(19) United States
(12) Patent Application Publication
(10) Pub. No.: US 2002/0190490 A1
(43) Pub. Date: Dec. 19, 2002

(54) Golf bag

(76) Inventor: Fu-Hsiung Yang, Pan-Chiao (TW)

Correspondence Address: INTELLECTUAL PROPERTY / TECHNOLOGY LAW, PO BOX 14329, RESEARCH TRIANGLE PARK, NC, 27709, US

(21) Appl. No.: 09/957,058

(22) Filed: Sep. 20, 2001

(30) Foreign Application Priority Data
Jun. 14, 2001 (CN) 90209998

(51) Int. Cl. B62B 1/24

(52) U.S. Cl. 280/47.131

(57) ABSTRACT

A golf bag includes a bag body and a sliding means fixed at the bottom of the bag body. The sliding means is provided with at least one eccentric front wheel for changing direction and two fixed rear wheels whose diameter are larger than the eccentric front wheel. If required, a handle can be provided on the same side above the rear wheels at the upper end of the bag body such that the golf bag can be slanted and pulled when users grasp the upper end of the bag body or pull the handle in order to drive the rear wheels.

### BACKGROUND OF THE INVENTION

1. Field of the Invention

The present invention relates to a golf bag in general, and in particular to a golf bag having larger rear wheels suitable for moving, and a smaller eccentric front wheel for changing moving direction.

2. Description of the Prior Art

When playing golf, the total weight of a golf bag containing more than ten golf clubs will amount to more than ten kg. Therefore, it is very important if the golf bag is easy to carry and facilitate to move.

Prior art device, such as Taiwanese Utility Model Patent Publication No. 314800 “A Golf Bag” invented by the same inventor, disclosed a golf bag including wheels and a fixed handle which is easy to carry and facilitate to move; however, only two small fixed rear wheels are installed thereon such that users have to apply a remarkable force to overcome the friction force for moving the bag on the fairway; in addition, the design of the fixed rear wheels can not help to change the moving direction so that the bag is difficult to be used. Besides, when the golf bag is filled with golf clubs, the fixed handle or the user's hand will be hampered by the head of golf clubs.

Another prior art device, Taiwanese Utility Model Patent Publication No. 353970 “A Golf Bag” invented by the same inventor, disclosed a golf bag including wheels and a retractable handle which solved the problem of the Taiwanese Utility Model Patent Publication No. 314800 that the fixed handle or the user's hand will be hampered by the head of golf clubs as mentioned above. However, the problems, that only two small fixed rear wheels are installed thereon such that users have to apply a remarkable force to overcome the friction force for moving the bag on the fairway and the fixed rear wheels can not help to change moving direction so that the bag is difficult to be used, are still not solved.

### SUMMARY OF THE INVENTION

A main object of the present invention is to solve the problems mentioned above. The golf bag in accordance with the present invention comprises a bag body and a sliding means fixed at the bottom of the bag body. If required, a handle can be provided on the same side above the rear wheels at the upper end of the bag body. The sliding means is provided with at least one eccentric wheel as the front wheel for changing direction and two fixed rear wheels taken as a moving support. The lower edges of the front wheel and the rear wheels are set to be co-planar such that the golf bag can be placed on the ground to be in a standing condition. Moreover, the diameter of the rear wheel is larger than the front wheel so that users need not to apply a remarkable force for moving the golf bag on the ground or fairway. When the golf bag is in a standing condition, users can grasp the upper end of the bag body and push the bag body so as to drive the front wheel and rear wheels in a pushing condition. Alternatively, users can slant the golf bag by taking the rear wheels as a pivot and lifting the front wheel away from ground, then grasp the upper end of the bag body and pull the bag body so as to drive the rear wheels in a pulling condition. In addition, if required, a handle can be provided on the same side above the rear wheels at the upper end of the bag body such that, when the golf bag is in a standing condition, users can grasp the handle and push the bag body so as to drive the front wheel and rear wheels in a pushing condition, or users can slant the golf bag by taking the rear wheels as a pivot and lifting the front wheel away from ground, then grasp the handle and pull the bag body so as to drive the rear wheels in a pulling condition.

It is an object of the present invention to provide a golf bag which has a sliding means provided with wheels for being stably placed on the ground in order to facilitate the moving of the golf bag.

It is another object of the present invention to provide a golf bag which has an eccentric wheel as front wheel on one side of the bottom of the bag body for facilitating to change moving direction, and two rear wheels with larger diameter on the other side of the bottom of the bag body for facilitating to move the golf bag and increasing the stability. In case of two front wheels are installed, the distance between the centers of the two front wheels is smaller then the one between the centers of two rear wheels so as to increase the stability in the standing condition.

It is a further object of the present invention to provide a golf bag having a sliding means which has the advantages of simple construction, hard to come off, easy maintenance, easy manufacture, and easy to be used.

It is a further more object of the present invention to provide a golf bag having a sliding means which occupies little space such that users can choose to carry it on the back, to push it, or to pull it to the destination easily.

### BRIEF DESCRIPTION OF THE DRAWINGS

These and other attributes of the present invention will become more clear upon a thorough study of the following description of the preferred embodiments for carrying out the invention, particularly when reviewed in conjunction with the drawings, wherein:

FIG. 1 is a side view of the first embodiment of the golf bag in accordance with the present invention showing its standing condition;

FIG. 2 is a side view of the golf bag of FIG. 1 showing the pushing condition of the bag;

FIG. 3 is a side view of the golf bag of FIG. 1 showing the pulling condition of the bag;

FIG. 4 is a perspective view showing the structure of the sliding means of the golf bag of FIG. 1;

FIG. 5 is a bottom view showing the sliding means of the golf bag of FIG. 1;

FIG. 6 is a side view of the second embodiment of the golf bag in accordance with the present invention showing its standing condition;

FIG. 7 is a side view of the golf bag of FIG. 6 showing the pushing condition of the bag;

FIG. 8 is a side view of the golf bag of FIG. 6 showing the pulling condition of the bag;

FIG. 9 is a bottom view of the sliding means of the third embodiment of the golf bag in accordance with the present invention;

FIG. 10 is a bottom view of the sliding means of the fourth embodiment of the golf bag in accordance with the present invention;

FIG. 11 is a side view of the fifth embodiment of the golf bag in accordance with the present invention showing its standing condition; and

FIG. 12 is a side view of the sixth embodiment of the golf bag in accordance with the present invention showing its standing condition.

### DESCRIPTION OF THE REFERENCE NUMERALS

21 golf bag

22 bag body

23 sliding means

24 wheel seat

25 rear wheel

26 axle

27 eccentric wheel

28 handle

### DETAILED DESCRIPTION OF THE PREFERED EMBODIMENT

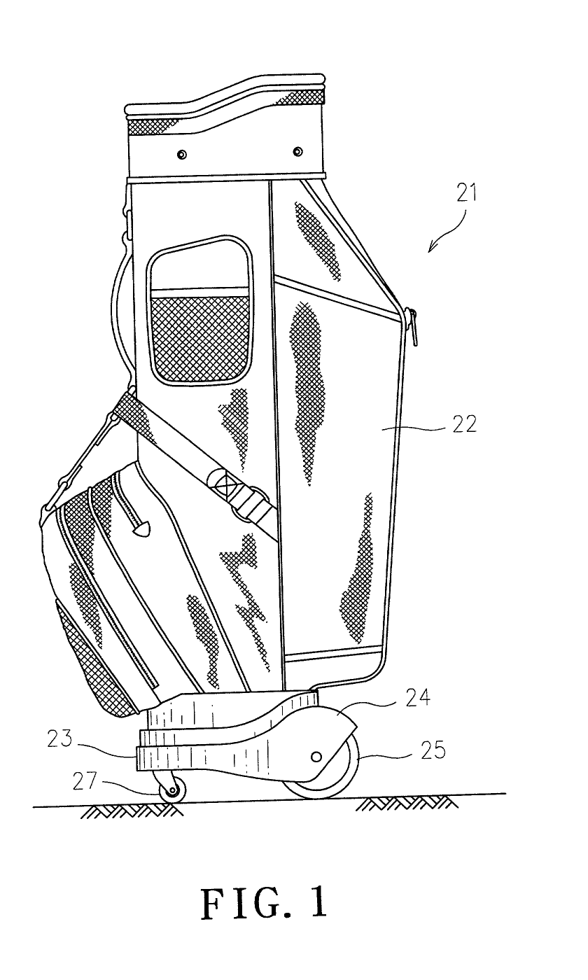

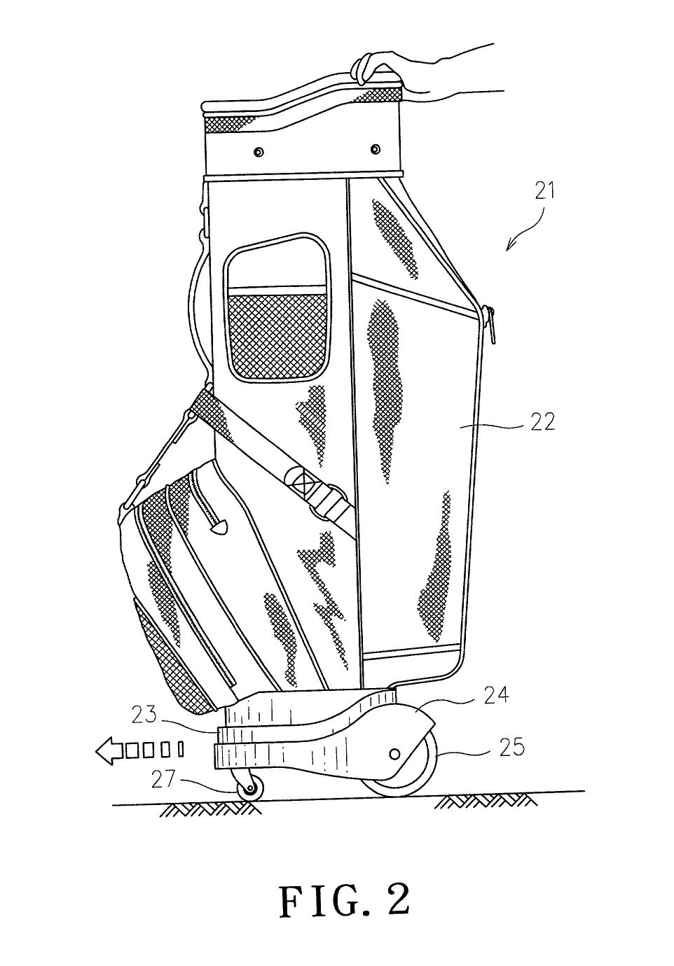

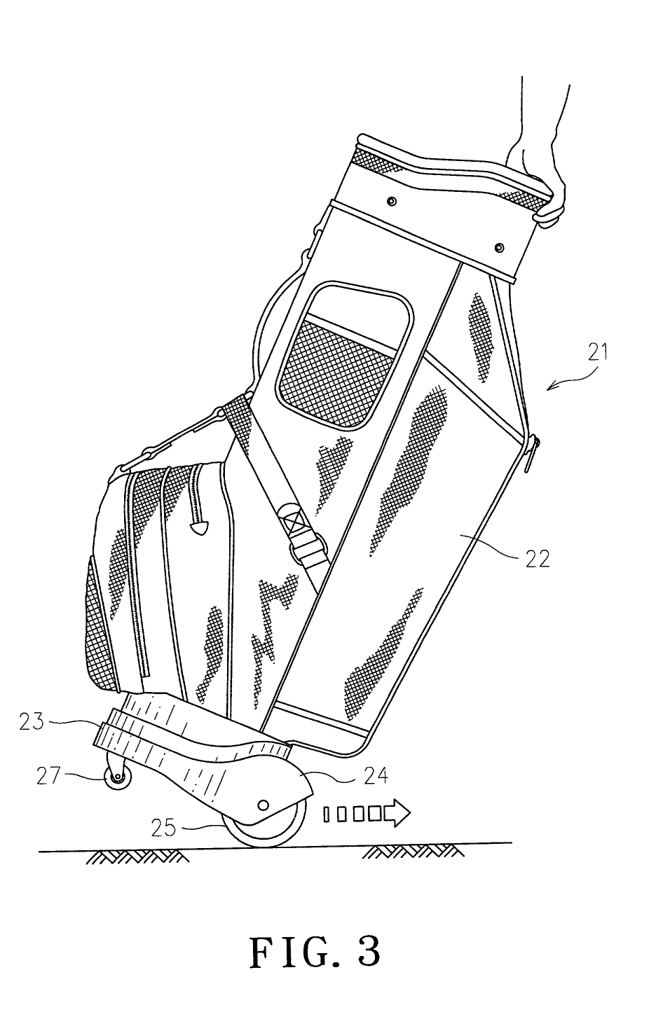

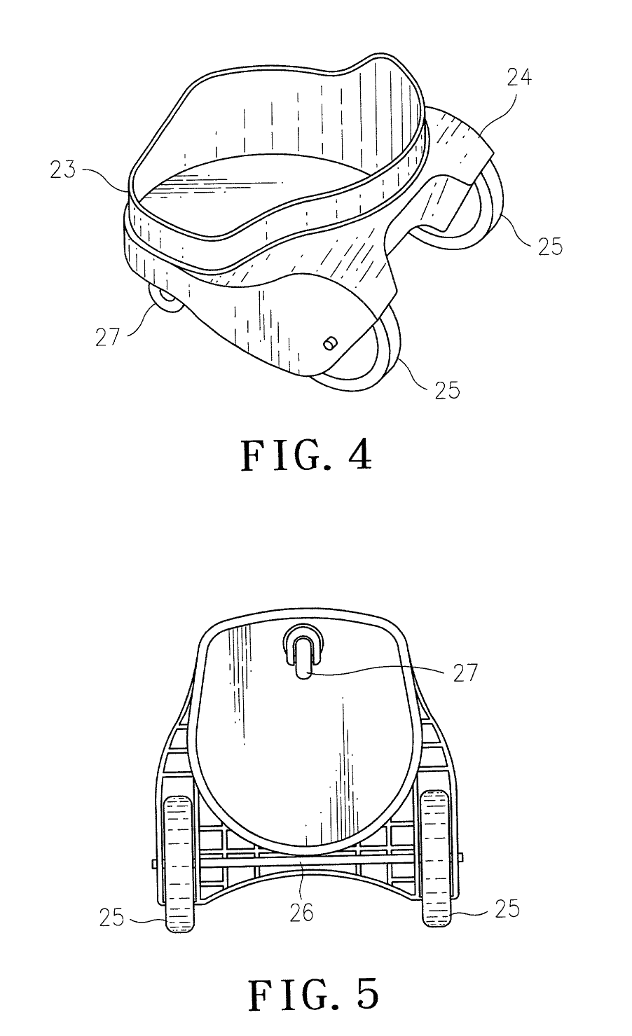

Please refer to FIG. 1 to FIG. 5, which illustrate the first embodiment of a golf bag according to the present invention. The golf bag 21 of the present invention mainly comprises a bag body 22 for receiving golf clubs (not shown) and a sliding means 23 fixed at the lower end of the bag body 22. The top of the sliding means 23 includes an internal surface and a peripheral wall extending from the internal surface so as to form a cylinder container such that the lower end of the bag body 22 can be fitted into and connected with the cylinder container of the sliding means 23. One side of the bottom of the sliding means 23 is provided with two wheel seats 24 parallel to each other for mounting two freely rolling rear wheels 25 (as shown in FIG. 5), and the two rear wheels are connected by an axel 26. At the bottom of the sliding means 23, another side opposite to said one side of the sliding means 23 is provided with an eccentric wheel 27 as a front wheel (as shown in FIG. 5). The lower edges of the eccentric wheel 27 and the rear wheels are set to be co-planar whereby the golf bag 21 can be stably placed on the ground to be in the standing condition as shown in FIG. 1. When the golf bag 21 is in the standing condition, users can grasp the upper end of the bag body 22 and push the bag body 22 so as to drive the front wheel 27 and rear wheels 25 in a pushing condition (as shown in FIG. 2). Alternatively, users can slant the golf bag 21 by taking the rear wheels 25 as a pivot and lifting the front wheel 27 away from ground, then grasp the upper end of the bag body 22 and pull the bag body 22 so as to drive the rear wheels 25 in a pulling condition (as shown in FIG. 3).

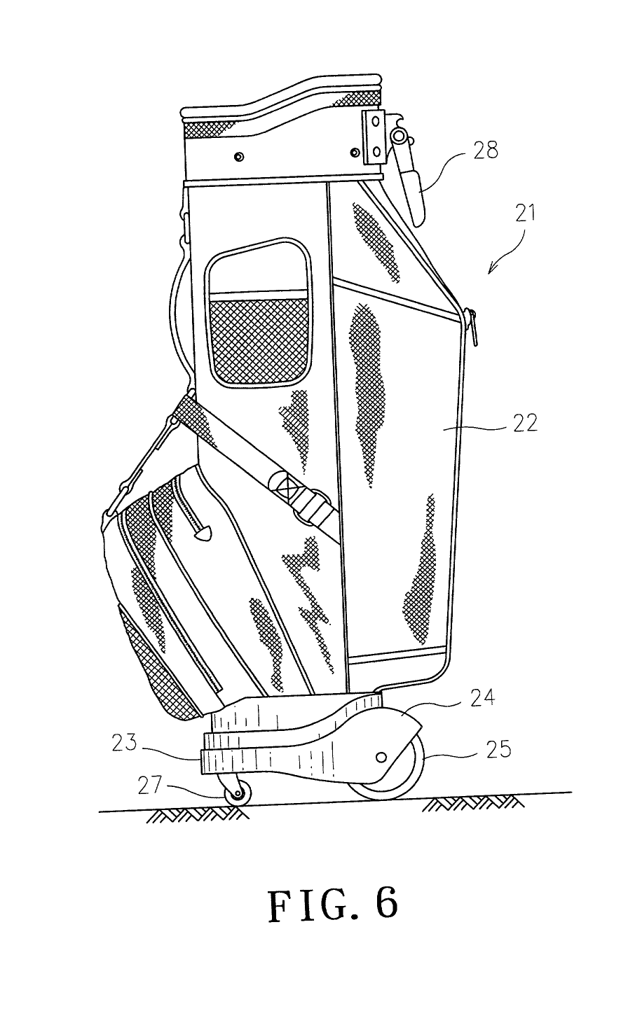

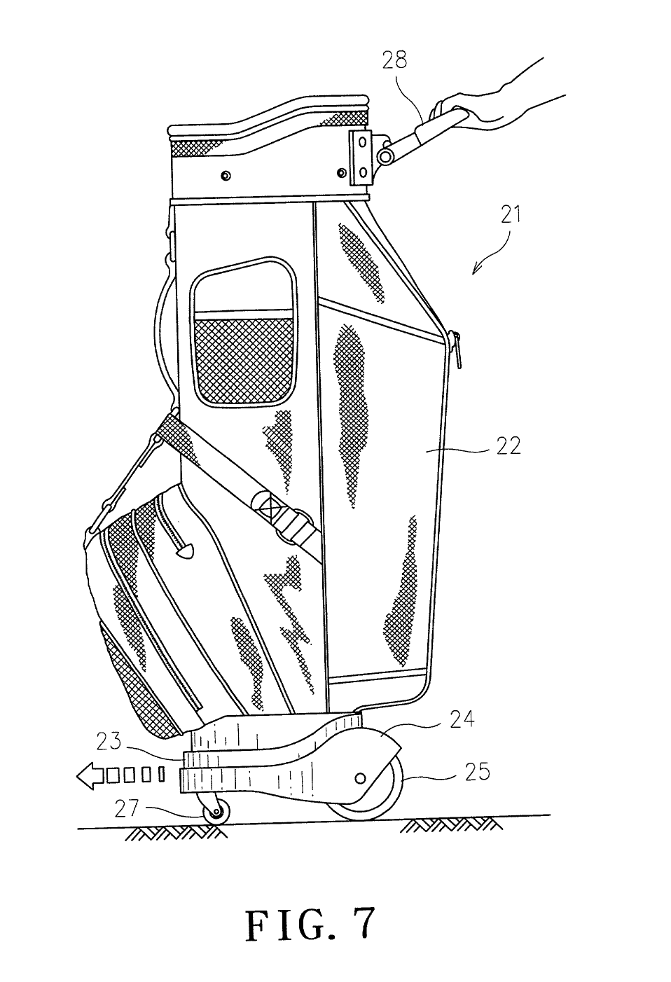

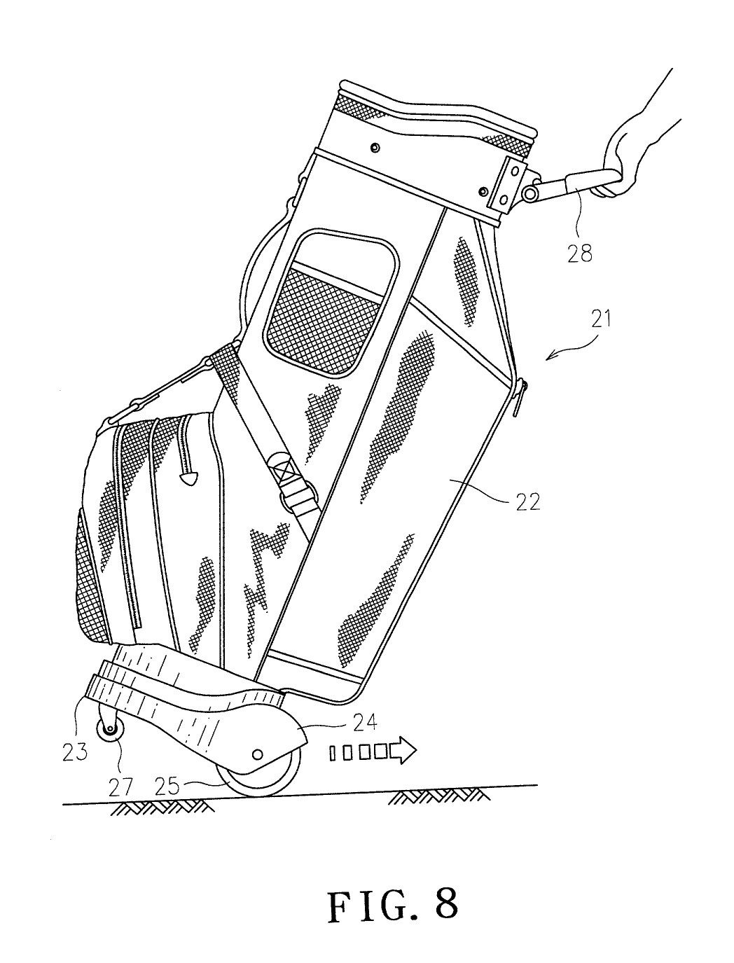

Please refer to FIG. 6 to FIG. 8, which illustrate the second embodiment of a golf bag according to the present invention. The second embodiment of the golf bag according to the present invention is accomplished by installing a handle 28 in the first embodiment according to the present invention. The handle 28 can be provided on the same side above the rear wheels 25 at the upper end of the bag body 22 such that, when the golf bag 21 is in the standing condition (as shown in FIG. 6), users can grasp the handle 28 and push the bag body 22 so as to drive the front wheel 27 and rear wheels 25 in a pushing condition (as shown in FIG. 7). Alternatively, users can slant the golf bag 21 by taking the rear wheels 25 as a pivot and lifting the front wheel 27 away from ground, then grasp the handle 28 and pull the bag body 22 so as to drive the rear wheels 25 in a pulling condition (as shown in FIG. 8).

In the first and the second embodiments according to the present invention, the sliding means 23 is preferably provided with an eccentric wheel 27 (as shown in FIG. 5) and the two rear wheels 25 so as to form three points touching the ground (as shown in FIG. 1). When the golf bag is moved and needs to change the moving direction, the eccentric wheel 27 is capable of providing the function of changing the direction. However, as shown in the third and the forth embodiments according to the present invention (will be described later), two eccentric wheels 27 accompanying with the two rear wheels 25 can also be provided with the function of changing direction and stably placing the bag on the ground as well.

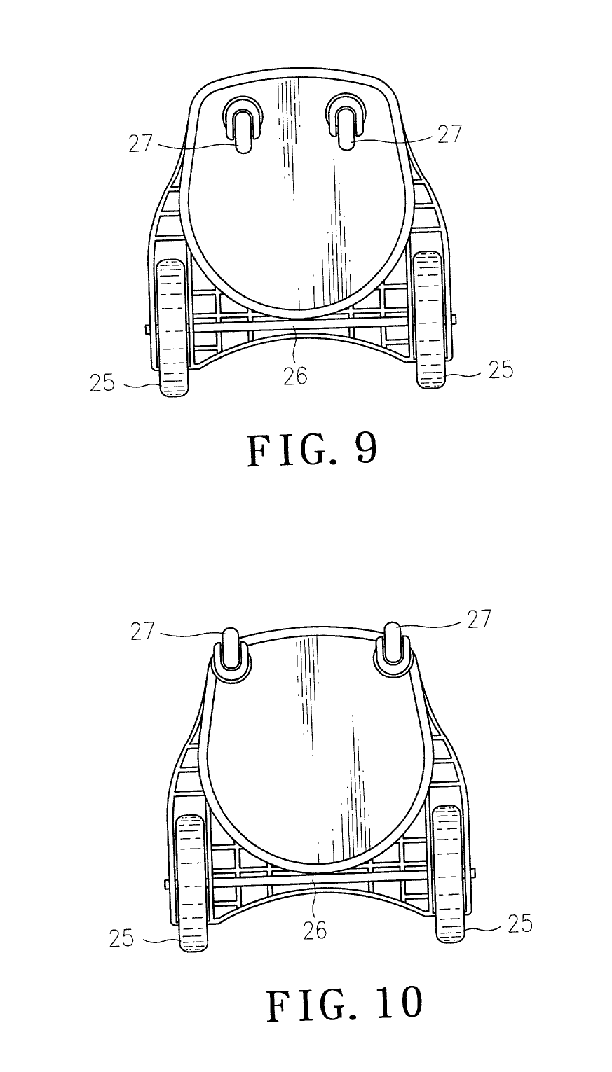

In the third embodiment according to the present invention (as shown in FIG. 9), there are two eccentric front wheels 27 installed, and the distance between the centers of the two rear wheels 25 is larger then the one between the centers of two front wheels 27 so as to increase the stability of the standing condition.

In the forth embodiment according to the present invention (as shown in FIG. 10), the two eccentric front wheels 27 installed on the sliding means 23 for changing direction can be arranged to project to the outside of the outer edge without affecting the function of changing direction.

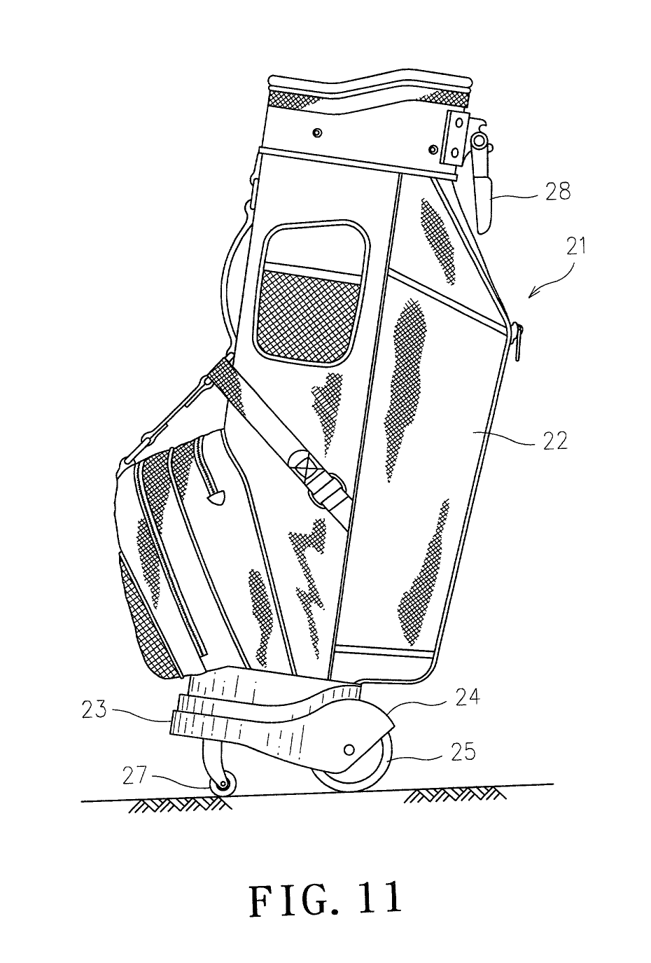

In the fifth embodiment according to the present invention (as shown in FIG. 11), no mater one eccentric wheel or two eccentric 27 are installed, the front wheel(s) can be elongated to slant the bag body 22 in order to shift the gravity center of the golf bag such that the bag is more stable in the standing condition.

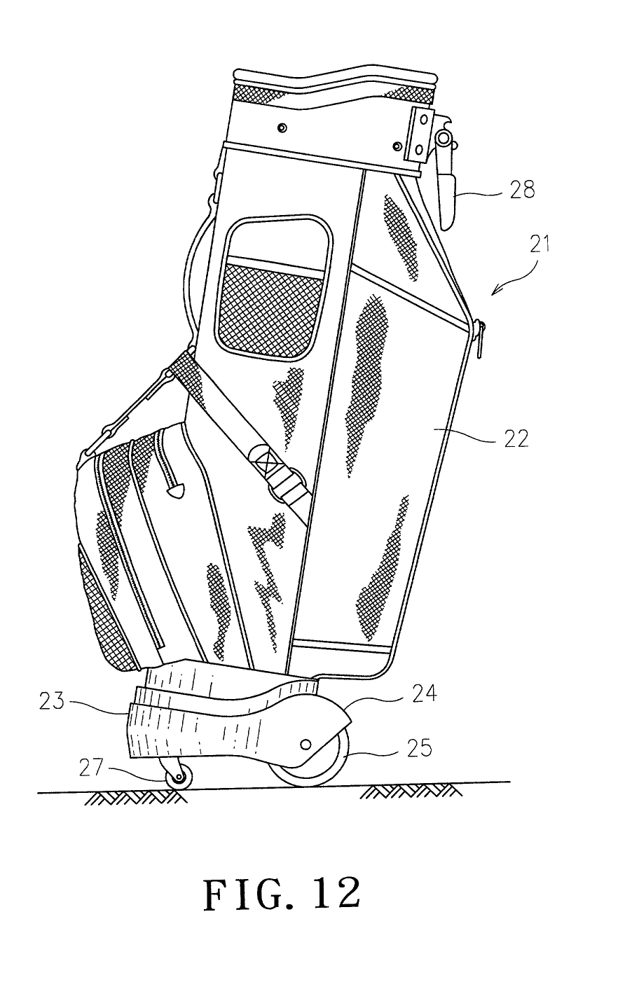

In the sixth embodiment according to the present invention (as shown in FIG. 12), the portion of the sliding means 23 for installing the front wheel 27 thereon can also be thicken to shift the gravity center of the golf bag such that the bag is more stable in the standing condition as well.

In all of the embodiments described above, the diameter of the rear wheel is larger then the eccentric front wheel (as shown in FIG. 1), typically by 2 to 4 times larger, preferably by 3 times larger, such that the bag can be pulled or pushed easily on both the ground and the fairway. The bag body 22 of the invention is simply an ordinary bag body 22 for receiving golf clubs, and the handle 28 is also an ordinary one such as a retractable handle, or a fixed handle. Since the bag body 22 and the handle 28 are not the characteristic parts of the invention and are all well known to the public, they are not described in detail in the present invention.

What is claimed is:

1. A golf bag comprising a bag body for receiving golf clubs and a sliding means fixed at the lower end of the bag body, a cylinder container formed on the top of the sliding means and connected with the lower end of said bag body; characterized in that:
one side of the bottom of the sliding means is provided with two wheel seats parallel to each other for mounting two freely rolling rear wheels connected by an axel;
another side opposite to said one side of the sliding means is provided with at least one eccentric wheel as a front wheel having a diameter smaller then the rear wheels;
the lower edges of the eccentric front wheel and the rear wheels are set to be co-planar such that the golf bag can be stably placed on the ground in a standing condition;
when the golf bag is in the standing condition, users can grasp the upper end of the bag body and push the bag body so as to drive the front wheel and rear wheels in a pushing condition; and
alternatively, users can slant the golf bag by taking the rear wheels as a pivot and lifting the front wheel away from ground, then grasp the upper end of the bag body and pull the bag body so as to drive the rear wheels in a pulling condition.

2. The golf bag as claimed in claim 1, wherein a handle can be provided on the same side above the rear wheels at the upper end of the bag body, and users can grasp the handle and push the bag body so as to drive the front wheel and rear wheels in a pushing condition, and alternatively, users can slant the golf bag by taking the rear wheels as a pivot and lifting the front wheel away from ground, then grasp the handle and pull the bag body so as to drive the rear wheels in a pulling condition.

3. A golf bag as claimed in claim 1, wherein the diameters of the rear wheels are 2 to 4 times larger then the diameter of the front wheel.

4. A golf bag as claimed in claim 1, wherein there are two eccentric front wheels installed on the sliding means.

5. A golf bag as claimed in claim 4, wherein the distance between the centers of the two rear wheels is larger then the distance between the centers of two eccentric front wheels.

6. A golf bag as claimed in claim 4, wherein the two eccentric front wheels installed on the sliding means is arranged to project to the outside of the outer edge of the sliding means.

7. A golf bag as claimed in claim 1, wherein the eccentric front wheel is elongated to slant the golf bag.

8. A golf bag as claimed in claim 1, wherein the portion of the sliding means for installing the front wheel thereon is thicken to slant the golf bag.
